(19) United States
(12) Patent Application Publication
(10) Pub. No.: US 2003/0036414 A1
(43) Pub. Date: Feb. 20, 2003

(54) Wireless earphone set

(76) Inventor: Ming Ji Huang, Taipei (TW)

Correspondence Address: CONNOLLY BOVE LODGE & HUTZ, LLP, 1220 N MARKET STREET, P O BOX 2207, WILMINGTON, DE, 19899

(21) Appl. No.: 09/929,691

(22) Filed: Aug. 14, 2001

(51) Int. Cl. H04M 1/00

(52) U.S. Cl. 455/569; 455/344

(57) ABSTRACT

A wireless earphone set, having a receiver-transmitter with a connecting end plugged into a mobile phone, and a remote unit with a receiver-transmitter and a jack for plugging in a connector to an earphone and a microphone. Thus voice signals are transmitted from and to the mobile phone without using a connecting cable. Optionally, a radio, cassette player or portable CD player is added, enabling a user to listen to radio, a cassette or a CD as well as using the mobile phone without exchanging earphones, while no possibly entangled connecting cable is used. Thus, independent of carrying the mobile phone on the body, in a pocket or in a bag, wireless transmission of voice signals allows for convenient listening and speaking.

### BACKGROUND OF THE INVENTION

1. Field of the Invention

The present invention relates to a wireless earphone set, and particularly, to a wireless held free earphone set for a mobile phone.

2. Description of Related Art

A conventional earphone A for a mobile phone 10, as shown in FIG. 1, is connected to the mobile phone 10 via a cable. During use, the length of the cable and the location of the mobile phone need to be adjusted, which is inconvenient. Tugging at the cable needs to be avoided, so as not to damage the cable or cause unreliable electric contact.

Wireless earphones on the market do not have these shortcomings, but are restricted to receiving signals from the mobile phone, having no other applications.

### SUMMARY OF THE INVENTION

It is the main object of the present invention to provide a wireless earphone set, having a receiver-transmitter with a connecting end plugged into a mobile phone, and a remote unit with a receiver-transmitter and a jack for plugging in a connector to an earphone and a microphone, so that voice signals are transmitted from and to the mobile phone without using a connecting cable.

Another object of the present invention is to provide a wireless earphone set, having a common acoustic circuit and an amplifier, allowing to add a radio, cassette player or portable CD player, enabling a user to listen to radio, a cassette or a CD as well as using the mobile phone without exchanging earphones, while no possibly entangled connecting cable is used. Thus, independent of carrying the mobile phone on the body, in a pocket or in a bag, wireless transmission of voice signals allows for convenient listening and speaking.

A further object of the present invention is to provide a wireless earphone set having an antenna and a battery in the remote unit and on an outer side thereof a volume controller and a manual and automatic power switch which, if turned off, upon an incoming call automatically turns on power.

The present invention can be more fully understood by reference to the following description and accompanying drawings.

### BRIEF DESCRIPTION OF THE DRAWINGS

FIG. 1 is a perspective view of a conventional earphone connected to a mobile phone via a cable.

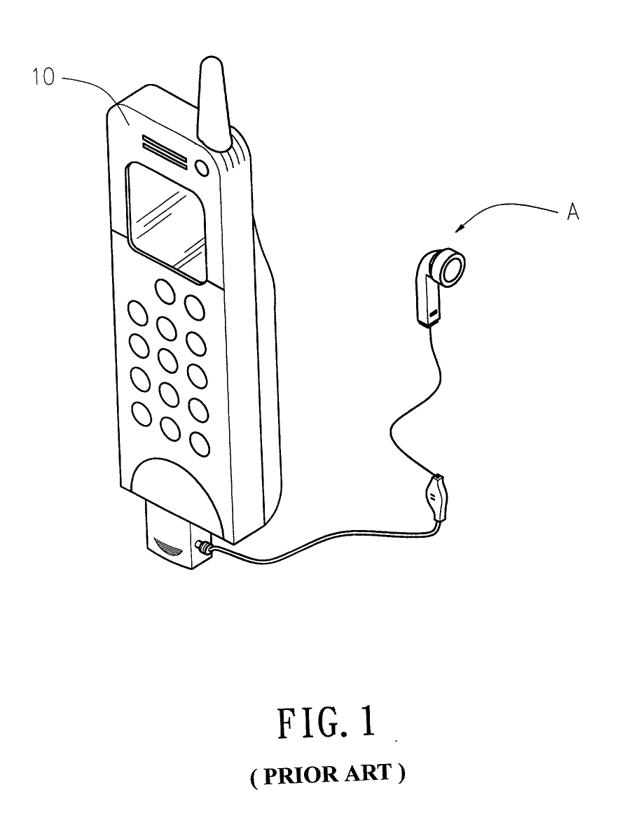

FIG. 2 is a perspective view of the wireless earphone set of the present invention.

FIG. 3 is a flowchart of the operation of the present invention.

FIG. 4 is a perspective view of the wireless earphone set of the present invention in another embodiment.

FIG. 5 is a perspective view of the wireless earphone set of the present invention in a further embodiment.

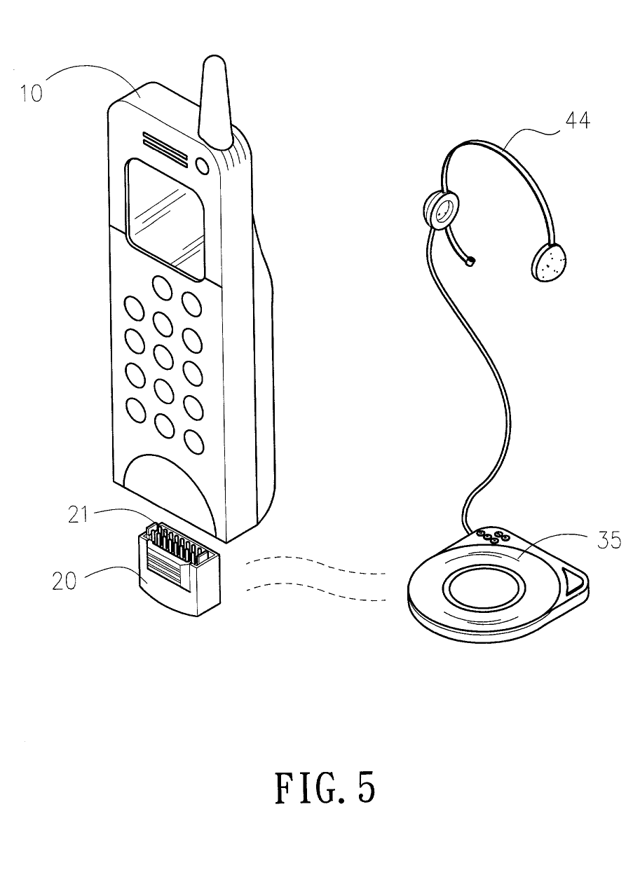

### DETAILED DESCRIPTION OF THE PREFERRED EMBODIMENTS

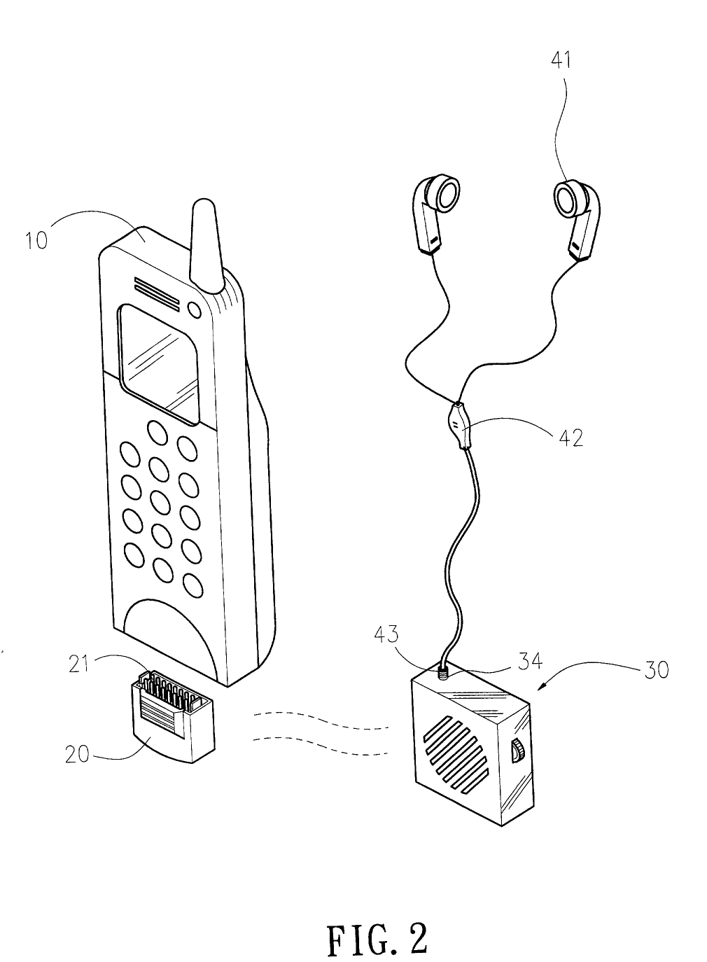

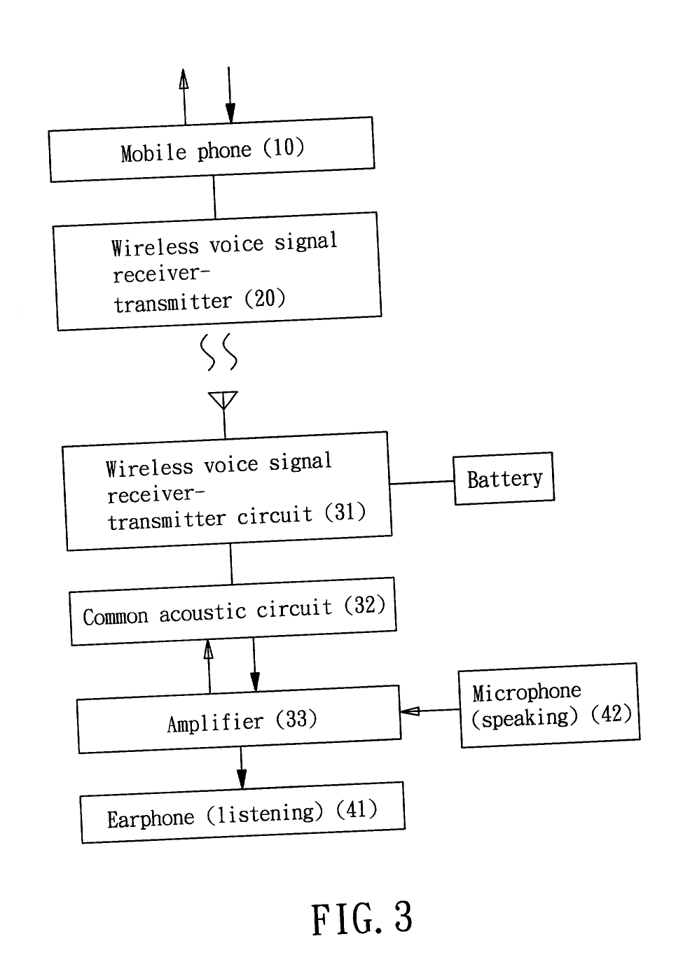

As shown in FIGS. 2 and 3, the wireless earphone set of the present invention in a first embodiment mainly comprises: a receiver-transmitter 20 with a connecting end 21 plugged into a mobile phone 10; and a remote unit 30, housing a receiver-transmitter circuit 31 and having a jack 34 at an outer side for plugging in a connector 43 for connecting an earphone 41 and a microphone 42.

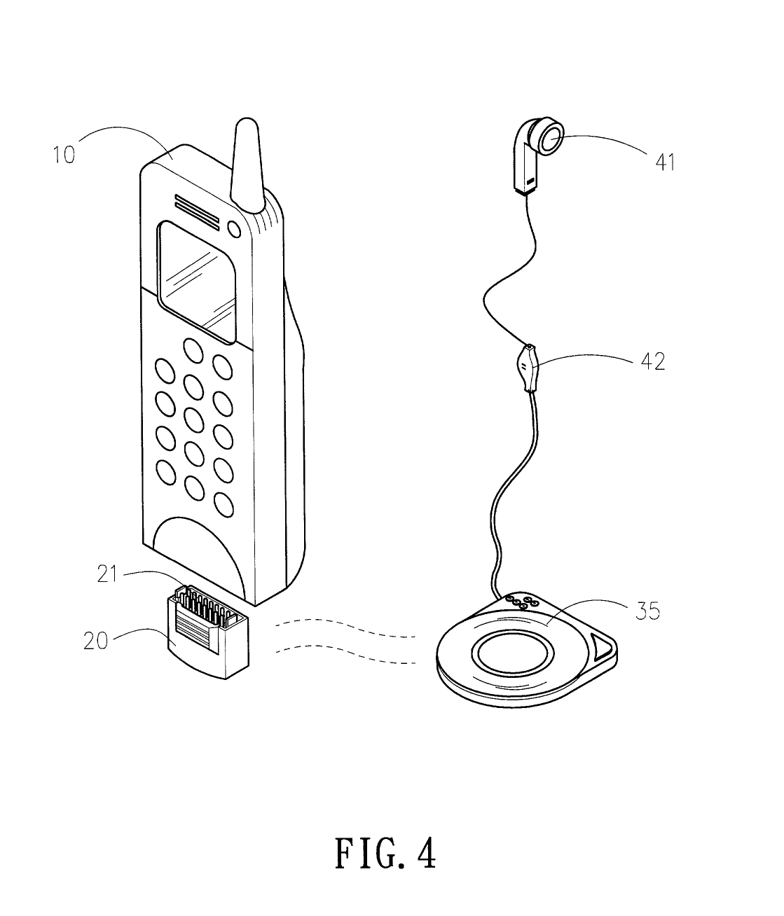

The remote unit 30 further houses a common acoustic circuit 32 and an amplifier 33, allowing to add a radio, cassette player or portable CD player 35, as shown in FIG. 4. Thus a user is enabled to listen to radio, a cassette or a CD as well as using the mobile phone without changing the earphone 41 and the microphone 42. No possibly entangled connecting cable is used. Thus, independent of carrying the mobile phone 10 on the body, in a pocket or in a bag, wireless transmission of voice signals allows for convenient listening and speaking.

Referring again to FIG. 3, operation of the present invention is as follows: The mobile phone 10 is connected with the receiver-transmitter 20, which gets a received voice signal from the mobile phone 10 and transmits the received voice signal to the remote unit 30. The receiver-transmitter circuit 31 in the remote unit 30 receives the received voice signal. The received voice signal are passed by the common acoustic circuit 32 to the amplifier 33 and from there to the earphone 41 to be heard.

When the user speaks into the microphone 42, a sent voice signal is amplified by the amplifier 33, passes through the common acoustic circuit 32 and is transmitted by the receiver-transmitter circuit 31 to the receiver-transmitter 20 on the mobile phone 10 to be sent out from there.

The remote unit 30 has an antenna and a battery and on an outer side thereof a volume controller and a manual and automatic power switch. When the remote unit 30 is turned off, the automatic power switch upon an incoming call automatically turns on power. Furthermore, the earphone 41 and the microphone 42 are replaceable by a headset 44 with an earphone and a microphone, which is held more stably.

While the invention has been described with reference to preferred embodiments thereof, it is to be understood that modifications or variations may be easily made without departing from the spirit of this invention which is defined by the appended claims.

1. A wireless earphone set, comprising:
a receiver-transmitter with a connecting end plugged into a mobile phone; and
a remote unit with a receiver-transmitter and a jack for plugging in a connector to an earphone and a microphone;
wherein voice signals are transmitted from and to said mobile phone without using a connecting cable.

2. A wireless earphone set according to claim 1, wherein said remote unit further has an antenna, a battery, a common acoustic circuit and an amplifier.

3. A wireless earphone set according to claim 1, wherein said remote unit on an outer side thereof has a volume controller and a manual and automatic power switch.

4. A wireless earphone set according to claim 1, wherein said remote unit is a cassette player.

5. A wireless earphone set according to claim 1, wherein said remote unit is a portable CD player.

6. A wireless earphone set according to claim 1, wherein said remote unit is a radio.
